(19) United States
(12) Patent Application Publication
(10) Pub. No.: US 2008/0026895 A1
(43) Pub. Date: Jan. 31, 2008

(54) Chain Drive System

(75) Inventors: Michael J. Johnson, Spokane, WA (US); Richard A. McQuary, Spokane, WA (US); Steven J. Allard, Spokane, WA (US)

Correspondence Address: LEE & HAYES, PLLC, 421 W. RIVERSIDE AVE, STE 500, SPOKANE, WA, 99201, US

(73) Assignee: Pearson Packaging System, Spokane, WA (US)

(21) Appl. No.: 11/828,237

(22) Filed: Jul. 25, 2007

Related U.S. Application Data
(63) Continuation of application No. 60/820,305, filed on Jul. 25, 2006.

(51) Int. Cl. F16H 7/24

(52) U.S. Cl. 474/150

(57) ABSTRACT

Chain-drive systems and methods of operation are described that allow chain travel along a non-linear path. In one example, the chain-drive system comprises a chain guide defining a channel having at least one non-linear region. A chain, sized to move within the channel, is driven by a drive sprocket. In one example, the non-linear region could redirect the chain 180 degrees and obviate the need for an idler sprocket. In another example, two channels are defined in the chain guide, including regions wherein the channels are parallel and regions where they have an angularly skewed relationship.

### RELATED APPLICATIONS

This patent application claims priority to U.S. provisional patent application Ser. No. 60/820,305, titled “Container Indexing Flight System”, filed on Jul. 25, 2006, commonly assigned herewith, and hereby incorporated by reference.

### BACKGROUND

Chain driven systems are susceptible to a number of problems. One common problem arises when designing a chain drive system to fit within a crowded mechanical environment. Frequently, a number of idler sprockets are needed to direct a path of chain travel. Each idler sprocket introduces cost to the system, increases the parts count and overall system complexity, and may lower system reliability and a mean time between failures.

Similarly, conventional systems are inadequate to damp vibration and prevent “chain slap” within the chain driven system. As a result, vibration may result in rapid wear on system components. Additionally, “chain sag” due to the weight of the chain can result in increased repair frequency and cost. Moreover, an exposed chain can result in a hazardous work environment.

Accordingly, improved chain drive systems could result in lower initial and maintenance costs, a safer work environment, as well as fewer and shorter down times.

### SUMMARY

This Summary is provided to introduce a selection of concepts in a simplified form that are further described below in the Detailed Description. This Summary is not intended to identify key features or essential features of the claimed subject matter, nor is it intended for use as an aid in determining the scope of the claimed subject matter.

Chain-drive systems, including chain guide components and methods of operation, are described. In one example, a chain guide is configured to allow chain travel along a non-linear path. In a further example, the non-linear region of the chain guide redirects chain travel 180 degrees to obviate the need for an idler sprocket. In a still further example, the chain-drive system comprises a chain guide defining two channels that include regions wherein the channels are not linear. And in a further example of a chain guide having two channels, the channels are linear in some regions, non-linear in other regions, parallel in some regions and have an angularly skewed relationship in other regions.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different figures indicates similar or identical items.

FIG. 1 illustrates a first example of a chain guide, including an orthographic view and two isometric views of the chain guide.

FIG. 2 illustrates a second example of a chain guide, including an orthographic view of the chain guide with the chain removed for clarity, a cross-sectional view of the chain guide, an orthographic view of a chain drive system incorporating the chain guide within a system having a chain, a drive sprocket and a connecting bar (attachment bar) installed, and an isometric view of the guide system.

FIG. 3 illustrates a third example of a chain guide and an example chain-drive system, including an orthographic view of the chain guide with the chain removed for clarity, a cross-sectional view of the chain guide and an isometric view of the chain drive system including a chain guide, a drive sprocket, a chain, a flight lug carried by the chain and a motor driving the chain.

FIG. 4 illustrates a fourth example of a chain guide and a further example of a chain-drive system, including an orthographic view of the chain guide with the chain removed for clarity, a cross-sectional view of the chain guide, an orthographic view of the chain-drive system with the chain guide, a chain and a drive sprocket in an assembled condition, an isometric view of the chain-drive system and an isometric view of the chain-drive system in an inverted application.

### DETAILED DESCRIPTION

Overview

Chain-drive systems, including chain guide components and methods of operation, are described. In one example, a chain guide is configured to allow chain travel along a non-linear path. In one example of the non-linear path, the chain guide redirects chain travel by 180-degrees, thereby obviating the need for an idler sprocket. In a further example, a chain guide within the chain-drive system defines two channels arranged to include regions wherein one or more of the channels is non-linear. And in a further example of a chain guide having two channels, the channels are linear in some regions, non-linear in other regions, parallel in some regions and have an angularly skewed relationship in other regions.

### EXAMPLE SYSTEMS AND COMPONENTS

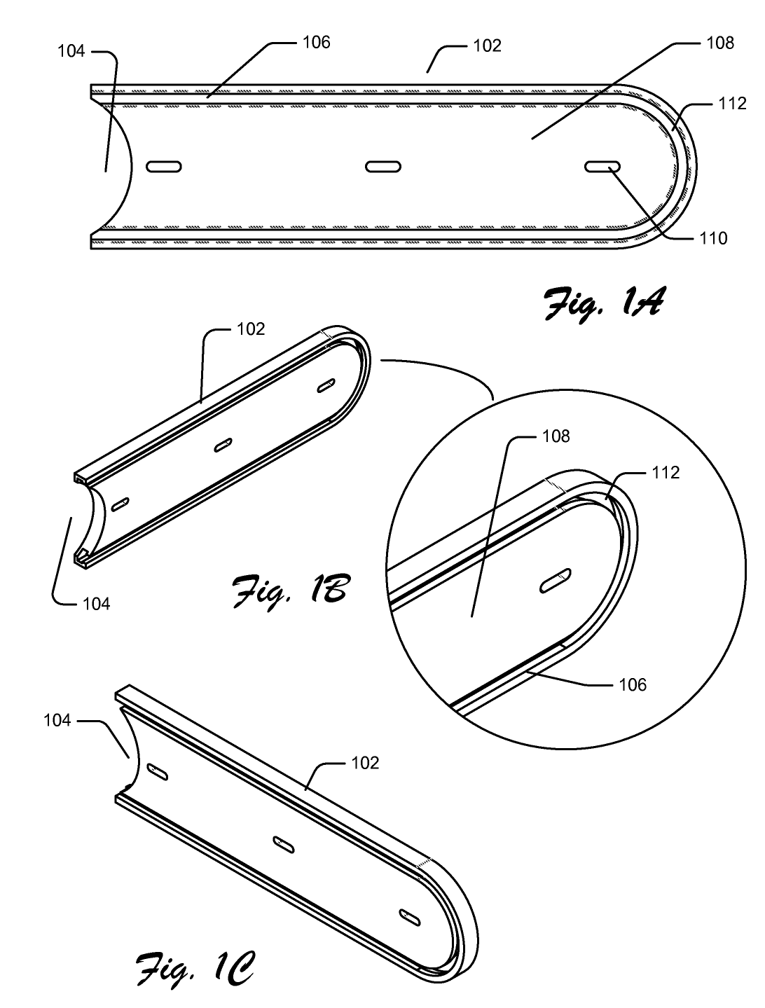

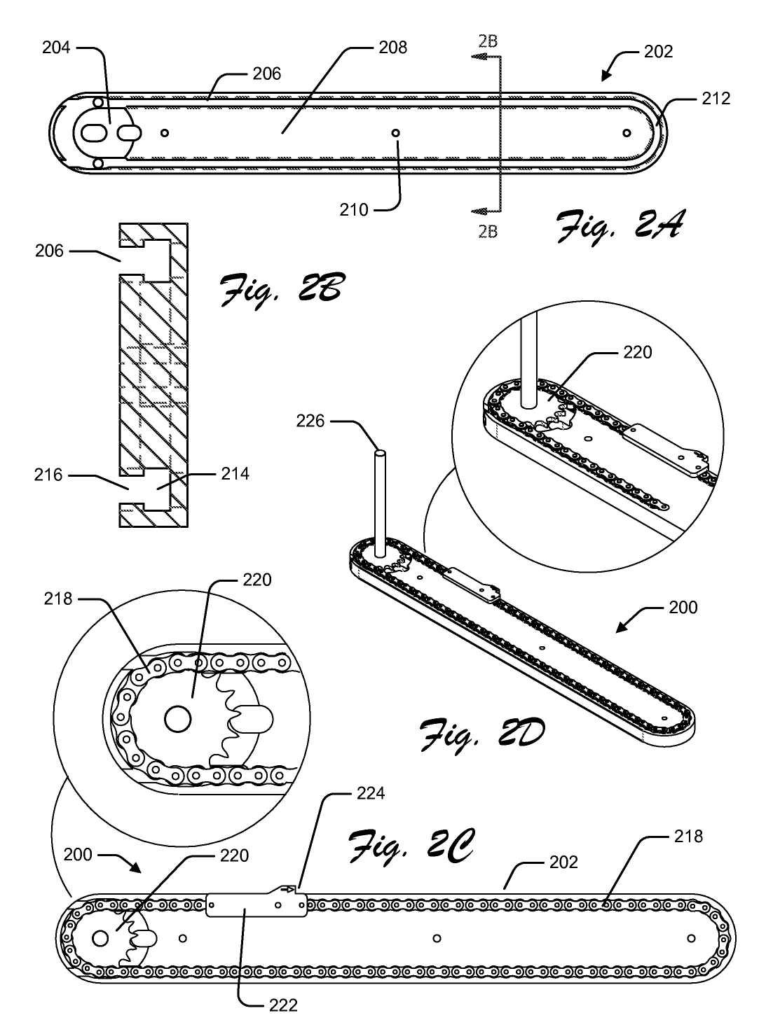

FIG. 1A shows an orthographic view of an example of a chain guide 102, configured for use in a chain-drive system or other chain-inclusive application. The chain guide 102 can be referred to as a “profile” or a “guide,” and may be included in many chain- and/or belt-driven systems and/or applications. The chain guide 102 can be configured as a long planar surface, within which is defined a channel sized to support and allow movement of a chain. In one example, the chain guide 102 may be utilized within a container indexing flight system, such as a conveyor system configured to assemble, fill and seal cases (e.g. cardboard boxes) associated with products, including almost any consumer, commercial and/or industrial good. The orthographic view of the chain guide 102 shows a first example of an indentation or region 104 sized to allow use of a drive sprocket (example drive sprockets are shown in various views of FIGS. 2-4). A channel 106 is defined within a body 108 of the chain guide 102. In the example of FIG. 1A, the channel 106 is sized to allow passage of a chain (shown in various views of FIGS. 2-4) which may be used to move containers, such as cardboard boxes used for shipping any consumer, commercial and/or industrial products. A number of slots 110 defined in the body 108 allows a position of the chain guide 102 to be adjusted with respect to machinery or other location within the system, thereby tensioning an associated chain. For example, bolts or jack bolts can be used to finely regulate the position of the chain guide 102, and in so doing regulate the tension applied to a chain moving through the channel 106. Such slots also allow adjustment of the chain guide, which may be required, for example, if there is wear within the channel due to contact with a moving chain over time.

In a preferred example, the walls of the channel 106 are sized to provide support to the chain, and to thereby overcome forces of gravity that may otherwise cause the chain to sag or bow as it spans between points of support. This is particularly true if the chain is oriented with its links (side plates) in a horizontal position and the rollers (bushings) vertically oriented. Additionally, the channel 106 is configured to result in a low frictional coefficient between the chain and the walls of the channel.

In a preferred example, the body 108 of the chain guide 102 is made of an ultra-high molecular weight (UHMW) material. Examples of such materials include, but are not limited to, polyethylene, nylon or Nylatron®, a type of oil-impregnated nylon.

A portion of the channel 106 defines a curved path 112 that provides much of the functionality of an idler sprocket. In the example of FIG. 1A, the curved path 112 provides for 180-degree redirection of a chain (the chain is not shown for clarity of the channel). While the 180-degree curved path is frequently useful, curved paths that redirect travel by a chain by values other than 180-degrees are also useful in many applications. For example, a curved path may deflect chain travel by 45 degrees.

FIG. 1B shows an isometric view of the example chain guide 102 shown in FIG. 1A. In particular, FIG. 1B shows an enlarged view of the 180-degree curved path 112 made by the channel 106, which is defined in the body 108 of the chain guide. Note that the channel 106 can be viewed as being first and second linear channels separated by a non-linear channel portion, which in the example of FIG. 1B is semicircular in configuration. FIG. 1B also shows the indentation defining a region 104 within which a drive sprocket can be located. The curved indentation is typically defined using approximately the same radius as the drive sprocket.

FIG. 1C shows an additional isometric view of the example chain guide 102 shown in FIGS. 1A and 1B.

FIG. 2A shows a second example of a chain guide 202. The chain guide 202 defines a second example of a region 204 within which a drive sprocket could be located. A channel 206 is defined within a body 208 of the chain guide 202, and is sized to allow travel of a chain (seen in FIGS. 2C and 2D). The body 208 may be attached to a conveyor system or other machinery at fastening points 210. The chain-travel channel 206 includes a non-linear portion 212, which connects two linear portions adjacent to the semi-circle 212.

FIG. 2B shows a cross-sectional view of the channel 206 taken across the 2B-2B lines of FIG. 2A. In the example of FIG. 2B, the channel 206 defines a larger inner passage 214 and a smaller outer passage 216. That is, the inner passage 214 has a larger cross-sectional area than the outer passage 216, as can be seen by examination of FIG. 2B. The larger inner passage 214 is sized to allow travel of the side plates (i.e. the “links”) of the chain. The smaller outer passage 216 is sized to allow travel of the rollers (i.e. the “bushings”) of the chain. Moreover, the smaller outer passage 216 is sized to prevent the side plates (links) of the chain from passing through, or falling out of, the channel 206.

FIG. 2C shows an example of a chain drive system 200. In particular, FIG. 2C provides an orthographic view of the chain guide 202 with the chain 218 and drive sprocket 220 installed. The drive sprocket is installed within the region 204 that has been sized for that purpose. The drive sprocket 220 provides power or torque to the chain 218. The drive sprocket 220 is seized to rotate in the defined area 204 (better seen in FIG. 2A).

A connecting bar (sometimes referred to as an attachment bar) 222 is carried by the chain 218. The connecting bar 222 is intended to be representative of chain-propelled lugs for driving and/or pushing surfaces generally. Additionally, the single connecting bar 222 illustrated is also intended to represent a plural number of such lugs that could be used simultaneously in some example systems. Each such connecting bar 222 is sized, positioned and otherwise configured to push a mechanism (e.g. a guide rail) within the system or product (e.g. a box or case of goods) with a pushing surface 224 as shown. For example, the connecting bar may be configured for two-way movement limited to a first or second channel or portion thereof. Such two-way motion may be periodic and/or repetitive.

FIG. 2D shows an isometric view of the example chain drive system 200. In the example of FIG. 2D, the drive sprocket 220 is driven by an axel 226, which may in turn be powered by a motor (not shown).

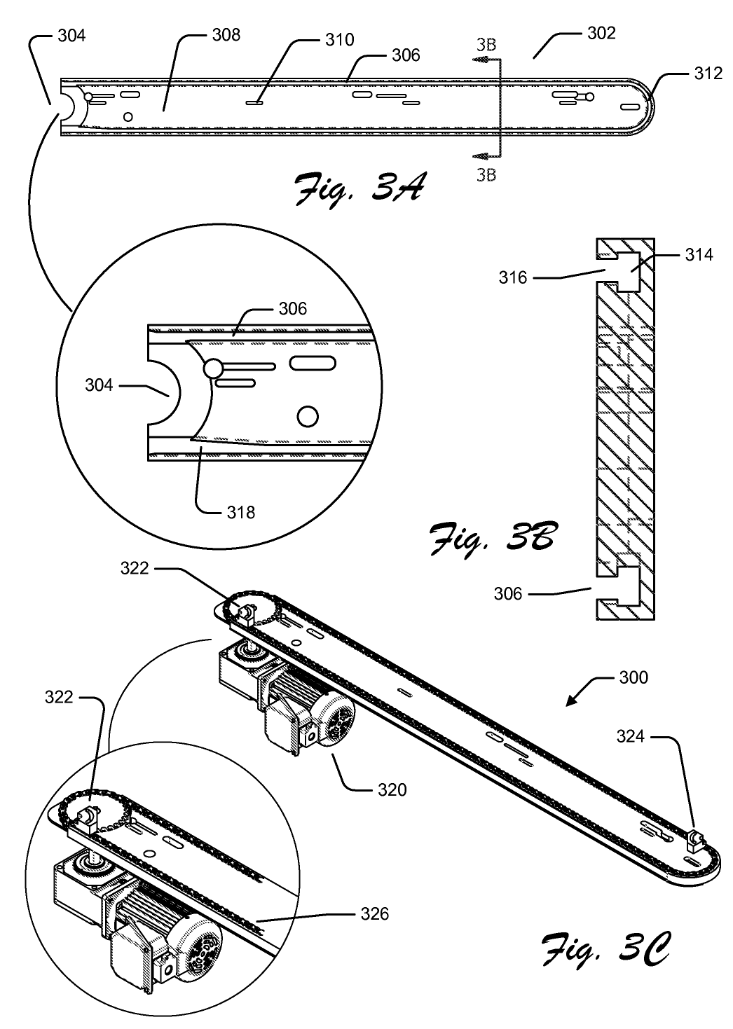

FIG. 3A illustrates a third example of a chain guide 302. The chain guide 302 defines a third example of a region 304 within which a drive sprocket may be located. A channel 306 is defined within the body 308 of the chain guide 302, wherein the channel 306 is sized to allow travel of a chain. Fastening slots 310 are elongated, to allow adjustment of the tension applied to the chain, as well as to provide means for attachment of the body 308 to any desired location within a conveyor system or other machinery.

In the example chain guide of FIG. 3A, a non-linear region 312 of the channel 306 is semicircular, and is therefore configured to redirect and/or return the chain over a 180-degree path. Accordingly, the non-linear region 312 obviates the need for an idler sprocket.

A slightly angled surface 318 results in a short portion of the channel 306 having a slightly wider cross-sectional area. This allows the chain, when moving from left to right across surface 318 (as seen in FIG. 3A) to more smoothly (i.e. with less friction and/or heat generation) enter the channel 306.

FIG. 3B shows a cross-sectional view similar to that of FIG. 2B, wherein a channel 306 defined in the body 308 of the chain guide 302 includes an internal region 314 and an external region 316, wherein the internal region is of greater cross-sectional area. The internal region 314 is sized for travel of the links (side plates) of the chain, while the external region 316 is sized for travel of the rollers (bushings) of the chain. Since the link cannot pass through the external region 316 due to their size, the chain is secured within the channel 306, and must initially be installed by forcing it into one end of the channel.

FIG. 3C shows a further example 300 of a chain drive system, wherein a motor 320 drives a chain 326 within the channel (labeled in FIGS. 3A and B), which in turn drives flight lugs 322, 324. In one example, the flight lugs are configured to push product, such as boxes or cases, along a conveyor system.

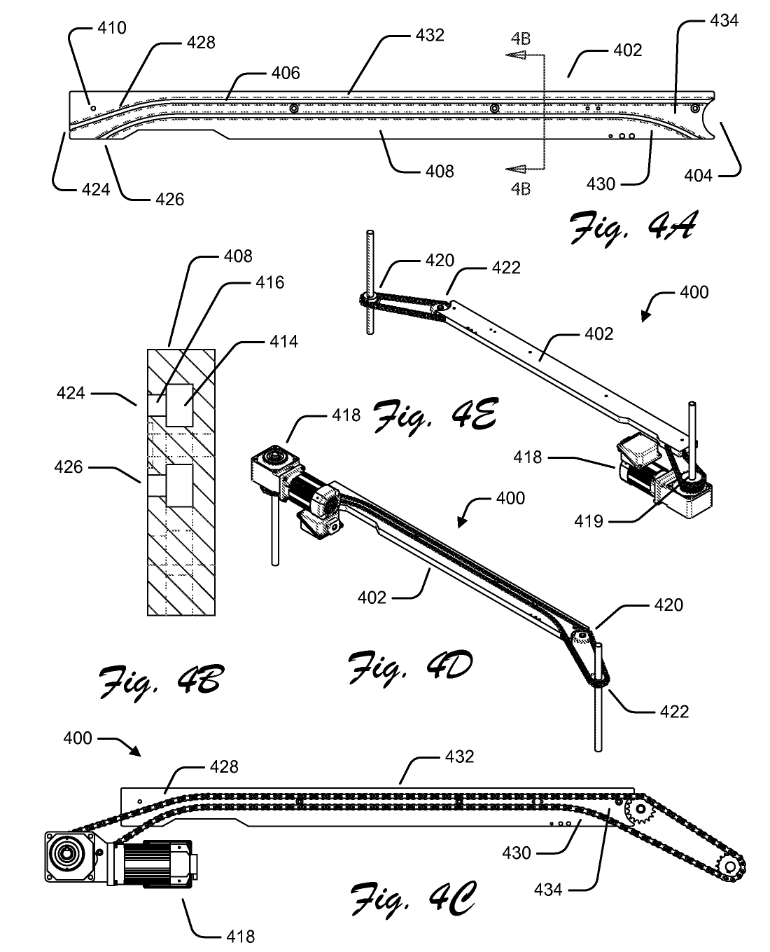

FIG. 4A shows a fourth example of a chain guide 402. The chain guide defines a fourth example of a region 404 within which a drive sprocket (or idler sprocket, if desired) may be located. A channel 406, defined in the body 408 of the chain guide 402, is sized to support and allow movement of a chain 436 (FIG. 4D). One or more fastening holes 410 allow the chain guide 402 to be secured in place and allow adjustment of the tension applied to the chain 436.

FIG. 4A additionally shows that two distinct channels are defined in the body 408. In particular, a first channel 424 and a second channel 426 have similarly sized cross-sections to allow travel of a chain. The first and second channels 424, 426 each include both linear (straight) portions 432, and non-linear (e.g. curving) portions 428, 430. Additionally, the first and second channels are related by regions wherein the two channels are parallel 432, and regions wherein the two channels have a skewed angular relationship 434, i.e. regions wherein the channels are not parallel. Thus, the body 408 of a chain guide can be shaped to allow channels 424, 426 that travel in any of a wide variety of pathways, to restrict chain travel to any desired location(s).

FIG. 4B, in conjunction with FIG. 4A, shows that the channels 406 defined in the body 408 of the chain guide 402 can be separated by a variable distance. Thus, the first and second channels 424, 426 retain the chain with larger inner regions 414 for travel of the chain's links and smaller outer regions 416 for travel of the chain's rollers/bushings. The relative sizes of the links, rollers, inner regions and outer regions combine to retain the chain within the channel. Note that the outer side plates (links) of the chain are outside the channel, and are therefore visible in FIGS. 4C and 4D. Thus, the chain, which is sized to move within the channel, is positioned so that side plates on a first side of the chain are within the channel and side plates on a second side of the chain are outside the channel.

FIG. 4C shows an orthographic view of the chain drive system 400, wherein the two channels (not seen because the chain is installed) have linear regions 432 and non-linear regions 428. In such non-linear regions, travel of the chain may be along a curved path. Additionally, the channels have regions 432 in which they are parallel, and regions 434 in which they are non-parallel (skew).

FIG. 4D shows that the chain drive system 400 and chain guide 402 can be used with a motor 418 to drive a drive sprocket 419 and one or more idler sprockets 420, 422. Curving regions of the channels 424, 426 allow flexibility in the design of the system 400, in part because the chain can be located and directed as desired.

FIG. 4E shows that the system 400 can be inverted without adverse impact on the functionality of the chain guide and/or chain operation. Thus, the chain guide 402 prevents the chain from sagging, eliminates or reduces vibration and “chain slap,” and can substantially reduce wear on the chain. Moreover, because the chain guide replaces a number of parts, such as idler sprockets, system reliability is increased. The inverted position seen in FIG. 4E can also result in a safer work environment, wherein the chain is not exposed.

### CONCLUSION

Although aspects of this disclosure include language specifically describing structural and/or methodological features of preferred embodiments, it is to be understood that the appended claims are not limited to the specific features or acts described. Rather, the specific features and acts are disclosed only as exemplary implementations, and are representative of more general concepts.

1. A chain-drive system, comprising:
a chain guide, wherein a channel defined within the chain guide comprises at least one non-linear region;
a chain, sized to move within the channel; and
a drive sprocket, positioned to drive the chain through the channel.

2. The chain-drive system of claim 1, wherein the at least one non-linear region is configured to redirect the chain approximately 180 degrees.

3. The chain-drive system of claim 1, wherein the chain guide additionally defines a second channel, which has a non-linear region and a region non-parallel to the channel.

4. The chain-drive system of claim 1, wherein the chain guide additionally defines a second channel, which has a region parallel to the channel and a region non-parallel to the channel.

5. The chain-drive system of claim 1, wherein surfaces defining the channel provide:
support to the chain to prevent the chain from sagging due to gravity; and
a low frictional coefficient with respect to the chain.

6. The chain-drive system of claim 1, wherein the chain guide additionally defines a region within which the drive sprocket is located.

7. The chain-drive system of claim 1, wherein the chain sized to move within the channel is positioned so that side plates on a first side of the chain are within the channel and side plates on a second side of the chain are outside the channel.

8. The chain-drive system of claim 1, wherein the channel defines an internal region and an external region, wherein the internal region is of greater cross-sectional area.

9. A chain guide, comprising:
an elongated planar surface defining a channel sized to support and allow movement of a chain; and
a non-linear region of the channel wherein travel of the chain is along a curved path;
wherein the channel defines an internal region sized to allow travel of chain side plates and an external region having smaller cross-sectional dimensions than the internal region and sized to allow travel of chain roller bushings.

10. The chain guide of claim 9, wherein the curved path redirects travel of the chain by approximately 180 degrees.

11. The chain guide of claim 9, wherein the elongated planar surface additionally defines bolt slots to allow tensioning of the chain.

12. The chain guide of claim 9, wherein the chain guide additionally defines a second channel, and wherein the channel and second channel are parallel in one region and non-parallel in another region.

13. The chain guide of claim 9, wherein the elongated planar surface defining the channel provides:
support to the chain to prevent the chain from sagging due to gravity; and
a low frictional coefficient with respect to the chain.

14. The chain guide of claim 9, wherein the chain guide additionally defines a region configured for locating a drive sprocket.

15. A chain-drive system, comprising:
a chain guide comprising an elongated planar surface defining first and second channels, each channel defining a larger inner passage and a smaller outer passage, wherein in at least one region the first and second channels are in a skewed angular relationship and wherein each of the first and second channels includes a non-linear portion;
a chain, sized to move within the channels so that side plates on a first side of the chain are within the inner passage of the channels and side plates on a second side of the chain are outside the channels;
at least one flight lug, attached to the chain and moveable in response to movement of the chain; and
a drive sprocket, positioned to drive the chain through the first and second channels.

16. The chain-drive system of claim 15, wherein the first and second channels are connected by a channel defining a 180-degree semicircle.

17. The chain-drive system of claim 15, wherein surfaces defining the channels provide:
support to the chain to prevent the chain from sagging due to gravity; and
a low frictional coefficient with respect to the chain.

18. The chain-drive system of claim 15, wherein the chain guide additionally defines a region within which the drive sprocket is located.

19. The chain-drive system of claim 15, wherein the chain guide defines a region sized to allow rotation of an idler sprocket.

20. The chain-drive system of claim 15, wherein travel of the connecting bar comprises two-way movement limited to the first channel.
